(19) United States
(12) Patent Application Publication
(10) Pub. No.: US 2007/0261534 A1
(43) Pub. Date: Nov. 15, 2007

(54) METHOD AND SYSTEM FOR COMBINING NEWS AND MUSIC

(75) Inventor: Ashley P. ALLEN, San Francisco, CA (US)

Correspondence Address: SCHNADER HARRISON SEGAL & LEWIS, LLP, 1600 MARKET STREET, SUITE 3600, PHILADELPHIA, PA, 19103, US

(73) Assignee: CELLULAR RECORDS, San Francisco, CA (US)

(21) Appl. No.: 11/740,836

(22) Filed: Apr. 26, 2007

Related U.S. Application Data
(60) Provisional application No. 60/795,451, filed on Apr. 26, 2006.

(51) Int. Cl. G10H 7/00

(52) U.S. Cl. 84/603

(57) ABSTRACT

A method and system for packaging news and information with music to create a new form of information sharing. A digital file comprising audio information is created. A digital spoken word audio component and a plurality of musical components are provided. The sound properties of the digital spoken word audio component and each of the plurality of musical component are analyzed to select a musical component that sonically fits with the digital spoken word audio component. Further analysis is performed regarding when a portion of the digital spoken word audio component sonically fits with a portion of the selected musical component. The digital spoken word audio component and the selected musical component in the digital file is then synchronized.

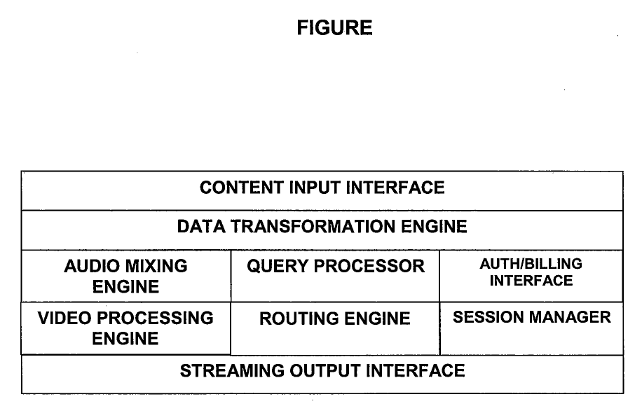

This application is based on, and claims priority to, U.S. provisional application Ser. No. 60/795,451, filed Apr. 26, 2006, and entitled Method and System for Combining News and Music.

### BACKGROUND OF THE INVENTION

Music has been combined with various audio and visual creations. It is often used to set a mood or otherwise affect the user's perception of the content. The music, however, typically has abrupt changes or otherwise is not fully integrated with other audio or visual components of the work. Accordingly, there is a need for a system and method that produces a smoothly mixed continuous listening experience with no abrupt change or distinct commercial break so the listener experiences a hypnotic, rhythmic stream of information.

### SUMMARY OF THE INVENTION

A unique method and system is disclosed for packaging news and information with music to create a new form of information sharing.

A digital file comprising audio information is created. A digital spoken word audio component and a plurality of musical components are provided. The sound properties of the digital spoken word audio component and each of said plurality of musical component are analyzed to select a selected musical component that sonically fits with the digital spoken word audio component. Further analysis is performed regarding when a portion of the digital spoken word audio component sonically fits with a portion of the selected musical component. The digital spoken word audio component and the selected musical component in said digital file is then synchronized.

### DESCRIPTION OF THE DRAWINGS

The figure depicts a schematic of a content input interface according to a illustrative embodiment of the invention.

### DETAILED DESCRIPTION OF THE INVENTION

Definitions

Embodiments of the invention will be referred to as NEWZIQ™, which is the fusion of news, or other information and music. It is a hybrid news-music product designed to deliver news and information to listeners. It is a new way to directly and/or subliminally deliver a message.

A NEWZIQ™ Program is an integrated stream of music and information (be it news, sports, advertising, weather, etc) distributed as a smoothly mixed continuous listening experience with no abrupt change or distinct commercial break. The listener experiences a hypnotic, rhythmic stream of information.

It is important to emphasize that each element of NEWZIQ™, the spoken word and music, carry equal weight. They are integrated. The music is specifically designed to carry the voice, the message and the brand of the information provider. The music can provide commentary to emphasize a point, to opine, to provoke feelings, and the like.

Production

NEWZIQ™ can be thought of as informative music. A production is a track or a mixed compilation of tracks. The basic methodology is to design a news-music product that fits the information and/or provider thereof. This is an iterative process that evolves into a sound and brand.

Once established one or more sets of NEWZIQ™ design templates are created. This enables mass replication of the sound-brand. A design template will contain specific instrumentation, music genres, audio effects, custom equalization, etc.

Presently, producers and engineers use commercially available digital audio technology to create design templates and productions. For example, Pro-tools, Reason, ACID and Logic can be used to produce NEWZIQ™ content. Commercials are produced using the same design templates. This creates a consistent sound. Digital audio technology is used to weave the news, information and ad productions together to create a seamless mix. Separate mixes can also be weaved together.

Access and Distribution

Web enabling technology and other computing technology are used to manage and to distributed NEWZIQ™ content and services. Free-and-for-fee services will be established. Content will be accessible via handheld devices, laptops, PCs, etc. across wireless broadband, LAN, satellite and any other appropriate forms of computing, storage and networking technology.

NEWZIQ™ Networked Services will be delivered to airports, hotels, airplanes, hospitals, bars, cafes, radio networks, TV networks and other media outlets. The service could be free or for fee. Any number of standard billing mechanisms may be used to levy charges when using the for-fee services. This may include a dial-up access mechanism that allows a consumer to dial a toll free number of fee based number to enable streaming NEWZIQ™ or other similar mechanisms including broadband access, internet access, and the like. The resulting stream is delivered to a destination playback device; the default is the calling device.

See section describing a NEWZIQ™ Aggregator for more detail regarding networked services and enabling technology.

Commercial Applications

The NEWZIQ™ concept and design when executed creates a News Media Outlet and Marketing Machine capable of delivering NEWZIQ™ products and services to customers anytime, anywhere. Access is contemplated to be ubiquitous. Political organizations, non-governmental organizations, news providers and marketing firms could target any demographic and deliver any message to consumers.

NEWZIQ™ is inherently “sticky” due to its smooth, continuous flow likened to a DJ mixed set. There is no abrupt change in format for commercials. Commercials are programmed in the mix. Hence, a listener is less inclined to change the channel as he or she would when listening to traditional broadcast. The illusion of continuous, commercial free music provides a platform for broadcast radio to deliver sponsored and commercial programming that competes with subscription based programming like satellite and cable radio.

Subliminal Marketing

NEWZIQ™ can be used to execute both direct and subliminal marketing campaigns. Musical hooks can be created from marketing collateral to subliminally market products to potential consumers.

Sell the News and Sell the Music

The synergistic relationship between the beat of the news and the customized musical production that accompanies it provides for an infinite supply of new and evolving news-music products. For example, a 24/7 headline news service could be enabled and delivered to businesses and consumers alike. Everyday, a customer will find something new to listen to and to purchase.

Automated Production and Distribution

Technology can be employed to automate the entire production, sale and distribution processes of NEWZIQ™ products and services. The automation technology will streamline manual processes involved in the workflow of repurposing news content from providers, and the automation technology will streamline consumer access and redistribution.

The NEWZIQ™ Aggregator is at the core of the automation process.

Aggregator

A NEWZIQ™ Aggregator is a software component that encapsulates digital audio mixing technology, streaming technology, data transformation technology, text-to-speech conversion technology, filtering and routing capabilities.

NEWZIQ™ aggregator produces NEWZIQ™ in real-time from any audio stream, text stream and or spoken word stream. Audio and spoken word streams correlate to meta-data streams carried in-band or out-of-band. The meta-data streams include information such as beats-per-minute, root key, index points and other mark-up information need to achieve real-time audio mixing. In some cases content may be in a form native to a digital audio workstation technology like ACID, Protools, etc. This is purely implementation dependent.

The Figure depicts a schematic of a content input interface according to a illustrative embodiment of the invention. The Figure provides a high-level architecture that describes the components in an aggregator.

Content Input Interface

This is the upstream/input component of the aggregator. It can connect to static and streaming audio, video and text based content located in databases, streamed from a data feed or delivered using a 3^{rd} party protocol and toolkit. The input could also be from another NEWZIQ™ aggregator. Some example, connectivity protocols and encoding include TCP/IP, UDP, RSS, MP3, AIFF, etc.

Content is served based on requests from the query processor. Alternatively, content could be allowed to flow throw a preconfigured transformation, audio/video processing, routing, billing and streaming path.

Data Transformation Engine

The transformation engine converts content to a form suitable for downstream components and systems. For example, text streams can be converted to spoken word audio streams. This component allows for a clear pass through as well. Codec transformation technology can be integrated and enabled as necessary. This component generates/transforms the meta-data stream that provides the details on how to further process the content stream.

Audio Mixing Engine

This engine applies digital audio mixing technology in real-time to audio input streams. This component could be viewed as “a real-time mash-up mechanism” replacing the manual roll of a mixing engineer. The component uses audio processing technology similar to technology found in loop based mixing tools like Apple Garage Band and Sony ACID. Clever use of buffers allows the component to buffer the audio data, process the control streams, and sync any number of audio content tracks in time while maintaining pitch and feel. It applies NEWZIQ™ design templates in real-time to guarantee the produced music meets the brand of the content provider.

This component works in concert with the content interface, data transformation engine, video processing engine and streaming interface.

For example, a conventional news headline text stream could be mixed/aggregated with a hip-hop music stream to produce NEWZIQ™ headlines in a hip-hop format. The same news stream could be mixed with a jazz music stream to produce NEWZIQ™ headlines in a jazz format.

Video Mixing Engine

This component processes graphic, video and audio content. It leverages software/hardware technology used in multimedia applications like Final Cut Pro, Vegas, etc. Clever use of buffers allow the component to process video streams, and meta-data to combine video streams, image streams and audio streams to produce real-time NEWZIQ™ Television.

This component works in concert with the content interface, data transformation engine, audio processing engine and streaming interface.

Query Processor

This component processes requests for content. It works in concert with the session manager and content interface. It routes requests for content to the appropriate upstream interface. Depending on the type of requests, content results are routed through the transformation/audio/video engines as necessary. Error messages are routed to the client through the session manager component.

Routing Engine

This component enables the routing of content across a network of aggregators. This implements a proprietary protocol that supports failover and recovery, content routing, routing table updates, real-time mash-up protocol, and potentially other aggregator to aggregator protocols to implement specific capabilities.

The real-time mash-up protocol provides a unique listening experience. A listener with a wireless handheld, laptop, PC or PDA can receive multiple NEWZIQ™ Streams that are mixed in time as if a live DJ were syncing the streams. The NEWZIQ™ aggregator in the handheld device is using its audio mixing engine and/or the video mixing engine to combine streams. The real-time mix is streamed to the local media player using an appropriate format.

Authentication and Billing Interface

This component can be implemented to integrate an ISP billing system, Internet billing system, authentication mechanism or other third party technology. It works in tandem with the session manager to establish client connections and levy charges for fee based services.

Session Manager

This component manages client sessions. Functions include client authentication, request processing and routing, status message propagation, quality of service maintenance and potentially other capabilities. This component works in concert with the billing, streaming and query processor interfaces.

Requests are marshaled to the appropriate components depending on the session state. For example, session initiation would require authentication and billing prior to processing a content requests. When authenticated, requests for content can be processed.

Requests may be formulated using XML or some other encoding. Requests may be delivered via HTTP, HTTPS, TCP/IP and UDP or extended to integrate a 3^{rd} party system.

Parsed requests for content are marshaled to the Query Processor.

Streaming NEWZIQ™ Interface

This component streams content to media players like iTunes, Windows Media Player, Real Player, and the like. It can be extended to stream content to other devices and networks using other protocols. For example, the streaming component can interface to In-Flight entertainment systems, radio networks, and cable and satellite radio.

Flexible and Extendable

The high-level architecture described in the previous sections can be implemented in hardware and/or software depending on the solution requirements. It may be implemented as a single multi-threaded application running in a handheld device, or it may be implemented as independent components loosely coupled through messaging running in a data center.

### EXAMPLE APPLICATIONS

The following scenarios provide deployment examples demonstrating the flexibility and applicability of the NEWZIQ™ concept and aggregator technology.

NEWZIQ™ News & Information Solution for Reuters
1) Newziq™ can be used in conjunction with a headline news service for world news
2) Content is downloaded from an internal website to the Newziq studio.

3) A Newziq™ producer uses a customized design template to produce a custom music bed for the specific news company brand of news delivery.
4) Mix the spoken word audio to the music bed. This may include ads from sponsors.
5) Post the production to the News company's site.
6) The News company is capable of delivering content via podcasts and rss feeds.

In addition, 24/7 Newziq™ programming can be implemented. This requires the creation of a production assembly line with musicians, editors and producers constantly creating Newziq™ content for the News company brand.

In the future, Newziq™ Aggregators will be deployed to streamline the production and distribution of 24/7 news. The aggregator network allows journalist, sponsors and music producers to publish news, information and music to the network. The aggregators can mix the news, information and ads with the custom music in real-time or in the background. The information is delivered to customers upon request.

NEWZIQ™ In-Flight Entertainment Solution

Newziq™ can be delivered to in-flight entertainment systems. The current systems are CD/Tape driven. Hence, a CD should be sufficient. In the very near future, airplanes will be Internet enabled with wireless capabilities. This will allow for the delivery of Newziq™ content to wireless devices in use. An aggregator should be installed on the computing equipment for in-flight entertainment.

NEWZIQ™ Radio Network Solution

Newziq™ can be delivered to radio stations and large networks like clear channel. This can be delivered today in the form of an rss feed, website posting or other proprietary protocol. An aggregator can be integrated into the system to deliver real-time Newziq™.

NEWZIQ™ Sidewalk Display Solution

Newziq™ solutions can be provided to exploit metro wi-fi systems and storefronts. For example, a wireless ipod user is walking along the sidewalk in a shopping district. In one block, 5 plasma screens line the windows of one store with each screen playing Newziq™ Television promoting a different product. As the user walks by a screen he/she can hear the audio broadcast. The closer she gets, the louder the signal. As she moves from one panel to the next, the previous audio stream fades out and the new stream fades in. Both streams are played in perfect time. If he stands directly between the two displays, he hears a perfectly synced mash-up of the two displays. As she walks along the displays, each Newziq™ stream mixes in and out smoothly.

NEWZIQ™ Television

Newziq™ Television is the fusion of Newziq™ and video imagery to deliver continuous streams of news and information. Video and film production tools will be used to produce content. NEWZIQ™ Television adheres to the same standard of seamless content integration to create an entertaining and fluid video-audio experience.

NEWZIQ™ Lounge Bar and Eatery

A Newziq™ Bar is a venue where Newziq™ and/or Newziq™ Television are central themes. A Newziq™ Bar may be located in a custom facility, an airport, sidewalk café, etc. State of the art sound systems and video display technology will fill the venue with Newziq™ and/or Newziq™ television.

While the invention has been described by illustrative embodiments, additional advantages and modifications will occur to those skilled in the art. Therefore, the invention in its broader aspects is not limited to specific details shown and described herein. Modifications, for example to the type of information incorporated, components of the system and applications of the technology may be made without departing from the spirit and scope of the invention. Accordingly, it is intended that the invention not be limited to the specific illustrative embodiments, but be interpreted within the full spirit and scope of the appended claims and their equivalents.

Claimed is:

1. A method for creating a digital file comprising audio information, comprising the steps of:
providing a digital spoken word audio component;
providing a plurality of musical components;
analyzing sound properties of said digital spoken word audio component and each of said plurality of musical component to select a selected musical component that sonically fits with said digital spoken word audio component;
further analyzing when a portion of said digital spoken word audio component sonically fits with a portion of said selected musical component; and
synchronizing said digital spoken word audio component and said selected musical component in said digital file.

2. The method of claim 1, wherein
said digital spoken word audio component has at least one item of spoken word metadata; and
each of said musical components has at least one item of music metadata;
said method further comprising the step of comparing said spoken word metadata with said music metadata for each of said plurality of musical components, to select, as the selected musical component, the musical component having the music metadata with the closest correspondence with said spoken word metadata.

3. The method of claim 2, wherein said spoken word metadata identifies the target audience of the digital spoken word audio component, and each of said items of music metadata identifies at least one appropriate target audience of the musical component.

4. The method of claim 2, wherein said comparing step uses a template to select said selected musical component.

5. The method of claim 1, wherein said digital file further comprises video information.

6. The method of claim 5 wherein said video information comprises an audio component, and said audio component is used in said method as said digital spoken word audio component.

7. The method of claim 1, further comprising the step of selecting one or more of said plurality of music components to substantially match the running time of said digital spoken word audio component.

8. The method of claim 1, further comprising the step of processing requests for content from a client system.

9. The method of claim 1, further comprising the step of routing said digital file along a computer network.

10. The method of claim 1, further comprising the steps of authenticating the identity of a client system and billing a client for the purchase of said digital file.

11. A system for creating a digital file, comprising a computer containing software to perform the method of claim 1.

12. The system of claim 11, wherein
said digital spoken word audio component has at least one item of spoken word metadata; and
each of said musical components has at least one item of music metadata;
said method further comprising the step of comparing said spoken word metadata with said music metadata for each of said plurality of musical components, to select, as the selected musical component, the musical component having the music metadata with the closest correspondence with said spoken word metadata.

13. The system of claim 12, wherein said spoken word metadata identifies the target audience of the digital spoken word audio component, and each of said items of music metadata identifies at least one appropriate target audience of the musical component.

14. The system of claim 12, wherein said comparing step uses a template to select said selected musical component.

15. The system of claim 11, wherein said digital file further comprises video information.

16. The system of claim 15 wherein said video information comprises an audio component, and said audio component is used in said method as said digital spoken word audio component.

17. The system of claim 11, wherein said method of claim 1 further comprises the step of selecting one or more of said plurality of music components to substantially match the running time of said digital spoken word audio component.

18. The system of claim 11, wherein said method of claim 1 further comprises the step of processing requests for content from a client system.

19. The system of claim 11, wherein said method of claim 1 further comprises the step of routing said digital file along a computer network.

20. The system of claim 11, wherein said method of claim 1 further comprises the steps of authenticating the identity of a client system and billing a client for the purchase of said digital file.

21. A computer system for creating a digital file, comprising
a means for providing a digital spoken word audio component;
a means for providing a plurality of musical components;
a means for analyzing sound properties of said digital spoken word audio component and each of said plurality of musical component to select a selected musical component that sonically fits with said digital spoken word audio component;
a means for further analyzing when a portion of said digital spoken word audio component sonically fits with a portion of said selected musical component; and
a means for synchronizing said digital spoken word audio component and said selected musical component in said digital file.

22. The system of claim 21, wherein
said digital spoken word audio component has at least one item of spoken word metadata; and
each of said musical components has at least one item of music metadata;
said method further comprising the step of comparing said spoken word metadata with said music metadata for each of said plurality of musical components, to select, as the selected musical component, the musical component having the music metadata with the closest correspondence with said spoken word metadata.

23. The system of claim 22, wherein said spoken word metadata identifies the target audience of the digital spoken word audio component, and each of said items of music metadata identifies at least one appropriate target audience of the musical component.

24. A computer readable medium comprising a digital file created using the method of claim 1.

25. A computer readable medium comprising software for performing the method of claim 1.
